(19) United States
(12) Patent Application Publication
(10) Pub. No.: US 2025/0043903 A1
(43) Pub. Date: Feb. 6, 2025

(54) ROTARY STAND STRUCTURE CAPABLE OF POSITIVELY AND NEGATIVELY ROTATING 360 DEGREES

(71) Applicant: L’s Giant Co., Taipei City (TW)

(72) Inventor: CHUNG-HO LAI, Taipei City (TW)

(21) Appl. No.: 18/229,163

(22) Filed: Aug. 1, 2023

(51) Int. Cl. F16M 11/20; F16M 11/22

(52) U.S. Cl. CPC F16M 11/2014; F16M 11/22; F16M 2200/08

(57) ABSTRACT

The present invention relates to a rotary stand structure capable of positively and negatively rotating 360 degrees, mainly including a main body, a rotary inner sleeve and a transmission component. The main body includes an outer sleeve tube and a plurality of foot stands outwardly radiated from the periphery of the outer sleeve tube. The rotary inner sleeve and the transmission component are arranged in the outer sleeve tube. The rotary inner sleeve at least includes an inner sleeve tube and at least a bearing sleeved on the outer periphery of the inner sleeve tube and contacted with an inner wall of the outer sleeve tube. In the transmission component, the small gear is driven by a motor to make the big gear rotate, and the rotary inner sleeve is driven to rotate concentrically with the outer sleeve tube via the bearing through the convex platform arranged on a top surface of the big gear to be adapted with a concave groove arranged on the bottom surface of the inner sleeve tube.

### FIELD OF THE INVENTION

The present invention relates to a foot stand mechanism, and in particular, to an electric rotary angle stand structure capable of positively and negatively rotating 360 degrees.

### DESCRIPTION OF THE PRIOR ART

A support foot stand for supporting an exhibit or an ornament on the market is usually a simple foot stand structure. Therefore, when the exhibit or the ornament needs to use electric power, an extension cord with a socket must be externally connected to perform a power supply action, but there is a risk of electricity leakage, short circuit, etc. occurred in the extension cord in use. Also, the arrangement of the extension cord may result in that the rotation of the exhibit or the ornament is to be limited, that the exhibit or the ornament when rotated to a certain angle will be limited at by the extension cord and has to be rotated reversely, and that a 360-degree rotation mode cannot be achieved by repeating both positive rotation and negative rotation. Therefore, there has been a self-powered support foot stand on the market. However, the support foot stand does not have an appropriate functional structure to be used when the exhibit or the ornament needs to be rotated and displayed.

As described above, there are still problems in the conventional technique now. Therefore, in view of the above-mentioned problems, the present inventor intends to make an improvement and an innovation, and a rotary stand structure capable of positively and negatively rotating 360 degrees has been finally successfully developed and completed through years of painstakingly deep consideration.

### SUMMARY OF THE INVENTION

In order to overcome the problems of the prior art, it is the object of the present invention to provide a safe and conveniently-usable rotary stand structure capable of positively and negatively rotating 360 degrees.

In order to achieve the afore-mentioned object, the present invention provides a rotary stand structure capable of positively and negatively rotating 360 degrees, mainly including a main body, a rotary inner sleeve and a transmission component. An outer sleeve tube is arranged in an axle center of the main body. The rotary inner sleeve is sleeved in the outer sleeve tube. The rotary inner sleeve includes an inner sleeve tube, at least a bear and a rubber sleeve. The bearing and the rubber sleeve are sleeved on an outer wall of the inner sleeve tube and contacted with an inner wall of the outer sleeve tube, to keep the rotary inner sleeve and the outer sleeve tube concentric. The transmission component is arranged below the rotary inner sleeve in the outer sleeve tube. The transmission component at least includes a motor, a small gear, a big gear, a wire, and an end socket. The small gear is connected to the motor, with the small gear being engaged with the big gear. There is a convex platform adapted with a concave groove arranged on the bottom surface of the inner sleeve tube on the top surface of the big gear. A plurality of collector rings are arranged in the inside of the big gear, with the collector rings are electrically connected to the end socket through the wire.

Wherein, the transmission component further includes a contact point bracket, a plurality of copper contact points being arranged on the contact point bracket, at least a compression spring being arranged on the bottom of the copper contact points, the copper contact points being abutted against through the compression spring, so that the copper contact points make contact with the collector rings continuously.

Wherein, the inner sleeve tube is arranged with a passage, and a part of the wire of the transmission component is arranged in the passage and extends to the outside of the inner sleeve tube.

Wherein, the transmission component further includes an external power source connection, and the external power source supplies electric power to the transmission component for use.

Wherein, the maim body, the rotary inner sleeve, and the transmission component are made of fire proofing plastic and metal.

### BRIEF DESCRIPTION OF THE DRAWINGS

FIG. 1 is a three-dimensional outside view of the present invention;

FIG. 2 is a three-dimensional exploded view of the present invention;

FIG. 3 is a three-dimensional outside view of another embodiment of the present invention.

### DETAILED DESCRIPTION OF THE INVENTION

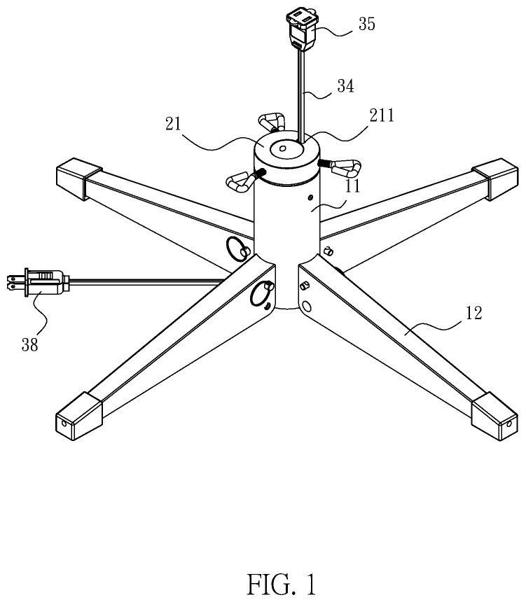

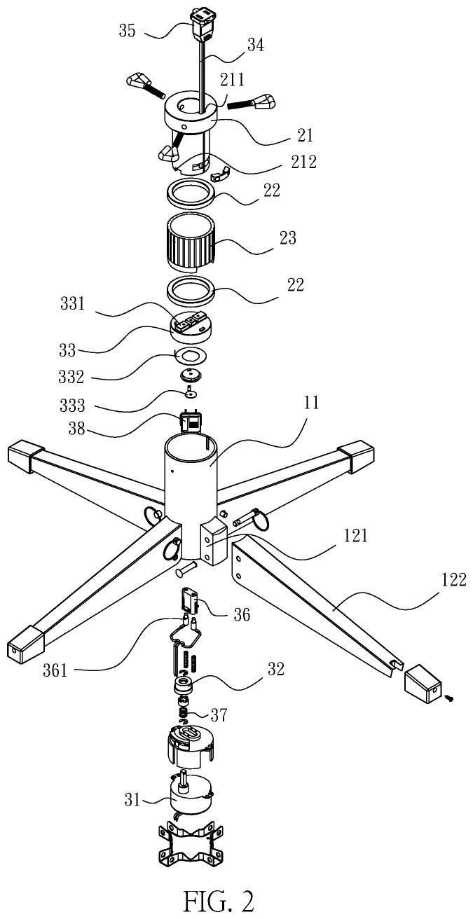

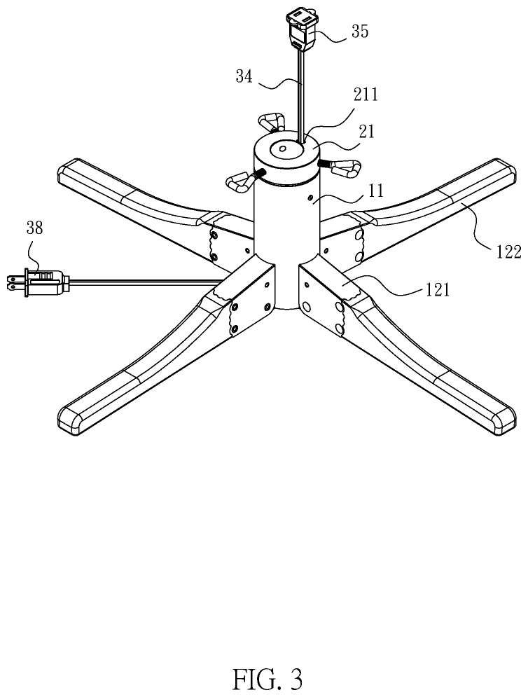

Referring to FIGS. 1, 2, and 3, a first embodiment of the rotary stand structure capable of positively and negatively rotating 360 degrees provided by the present invention is shown. In the embodiment, the rotary stand structure capable of positively and negatively rotating 360 degrees provided by the present invention at least includes a main body 1, a rotary inner sleeve 2 and a transmission component 3. An outer sleeve tube 11 is arranged in an axle center of the main body 1. A plurality of foot stands 12 used for supporting the main body 1 to achieve stably standing are outwardly radiated from the periphery of the outer sleeve tube 11. Furthermore, the foot stands 12 are consist of a positioning portion 121 connected to the periphery of the outer sleeve tube, and a support leg 122 and a fixing piece 123 corresponding to the positioning portion 121, wherein, in the embodiment, the fixing piece 123 is a flat-mouth fixing piece, and in another embodiment, the fixing piece 123 is a toothed-mouth fixing piece.

The rotary inner sleeve 2 includes an inner sleeve tube 21, two bearings 22 and a rubber sleeve 23. The inner sleeve tube 21 is arranged with a passage 211 penetrating through the inner sleeve tube. The rubber sleeve 23 and the two bearings 22 are sleeved on an outer wall of the inner sleeve tube 21, with the two bearings 22 being respectively arranged on a top portion and a bottom portion of the rubber sleeve 23. In addition, a concave groove 212 is recessed from a bottom surface of the rotary inner sleeve.

The transmission component 3 at least includes a motor 31, a small 20) gear 32, a big gear 33, a wire 34, an end socket 35, a contact point bracket 36, a compression spring 37 and an external power source 38. The motor 31 is connected to the gear shaft of the small gear 32, with the small gear 32 being engaged with the big gear 33. A convex platform 331 adapted with a concave groove 212 on the bottom surface of the inner sleeve tube 21 is arranged on a top surface of the big gear 33. Two collector rings electrically connected with the wire are arranged in the inside of the big gear 33. The collector rings include a big collector ring 332 and a small collector ring 333, with the big collector ring 332 and the small collector ring 333 being electrically connected to the end socket 35 through a wire 34. The contact point bracket is arranged below the big collector ring 332 and the small collector ring 333, with the contact point bracket 36 being arranged with a plurality of copper contact points 361. The compression spring 37 is arranged below the copper contact points 361, wherein a part of the wire 34 is arranged to pass through the passage 211 of the inner sleeve tube 21 and extends to the outside of the rotary inner sleeve 2, and the end socket 35 is arranged at the free end of the wire 34.

It is the main point of the rotary stand structure capable of positively and negatively rotating 360 degrees provided by the present invention to arrange the transmission component 3 and the rotary inner sleeve 2 into the outer sleeve tube 11. The transmission component 3 is connected to the rotary inner sleeve 2, by adapting a convex platform 331 of the big gear 33 in the transmission component 3 with a concave groove 212 on the bottom surface 15 of the inner sleeve tube 21 of the rotary inner sleeve 2. Then, the motor 31 is powered by the external power source 38, with the small gear 32 being used to drive the large gear 33 to rotate, to make the convex platform 331 and the concave groove 212 do linking-up motion, so that the rotary inner sleeve 2 is driven to make a coaxial-rotation in the inner sleeve tube 11 by means of the bearing 22. Further, the exhibit or the ornament mounted on the inventive rotary stand structure is driven to continuously make a rotary action, and it will be rotated reversely when it is subjected to external obstruction, or when it is subjected to touch, or when it is in contact with an obstacle. The exhibit or the ornament mounted on the inventive rotary stand structure is inverted to a state of continuous positive rotation again when it is subjected to external obstruction again. Meanwhile, according to the present invention, electric power is transmitted to the end socket 35 via the wire 34 from the external power source 38, by means of the two collector rings 332 and 333, so that it is possible to supply electric power from the end socket 35 to the exhibit or the ornament mounted on the inventive rotary stand structure for use.

The foregoing content only expresses some embodiments of the present invention, and are not intended to be a limitation to the scope of the present invention. A variety of changes and improvements could be made for by those of ordinary skill in the art without departing from the spirit of the invention, which are intended to be included within the scope of the invention as claimed.

### REFERENCE CHARACTER LIST

1 main body
11 outer sleeve tube
12 foot stand
121 positioning portion
122 support leg
123 fixing piece
2 rotary inner sleeve
21 inner sleeve tube
211 passage
212 concave groove
22 bearing
23 rubber sleeve
3 transmission component
31 motor
32 small gear
33 big gear
331 convex platform
332 big collector ring
333 small collector ring
34 wire
35 end socket
36 contact point bracket
361 copper contact point
37 compression spring
38 external power source

What is claimed is:

1. A rotary stand structure capable of positively and negatively rotating 360 degrees, comprising at least:
a main body with an outer sleeve tube being arranged in an axle center thereof;
a rotary inner sleeve sleeved in the outer sleeve tube, the rotary inner sleeve comprising an inner sleeve tube, at least a bear and a rubber sleeve, the bearing and the rubber sleeve being sleeved on an outer wall of the inner sleeve tube and contacted with an inner wall of the outer sleeve tube, to keep the rotary inner sleeve and the outer sleeve tube concentric; and
a transmission component arranged below the rotary inner sleeve in the outer sleeve tube and connected to the rotary inner sleeve, to drive the rotary inner sleeve to rotate in the outer sleeve tube through the transmission component.

2. The rotary stand structure capable of positively and negatively rotating 360 degrees of claim 1, wherein the transmission component at least comprises a motor, a small gear, a big gear, a wire, and an end socket, the small gear being connected to the motor, the small gear being engaged with the big gear, a convex platform adapted with a concave groove arranged on the bottom surface of the inner sleeve tube being on the top surface of the big gear, a plurality of collector rings being arranged in the inside of the big gear, the collector rings being electrically connected to the end socket via the wire.

3. The rotary stand structure capable of positively and negatively rotating 360 degrees of claim 2, wherein the transmission component further comprises a contact point bracket, a plurality of copper contact points being arranged on the contact point bracket, at least a compression spring being arranged on the bottom of the copper contact points, the copper contact points being abutted against through the compression spring, so that the copper contact points make contact with the collector rings continuously.

4. The rotary stand structure capable of positively and negatively rotating 360 degrees of claim 2, wherein the inner sleeve tube is arranged with a passage, and a part of the wire of the transmission component is arranged in the passage and extends to the outside of the inner sleeve tube.

5. The rotary stand structure capable of positively and negatively rotating 360 degrees of claim 2, wherein the transmission component further comprises an external power source connection, and the external power source supplies electric power to the transmission component for use.

6. The rotary stand structure capable of positively and negatively rotating 360 degrees of claim 1, wherein the maim body, the rotary inner sleeve, and the transmission component are made of fire proofing plastic and metal.
